(19) United States
(12) Patent Application Publication
(10) Pub. No.: US 2005/0029375 A1
(43) Pub. Date: Feb. 10, 2005

(54) Mechanical delaying device of shredder

(76) Inventor: Ming-Hui Ho, Taipei Shien (TW)

Correspondence Address: BACON & THOMAS, PLLC, 625 SLATERS LANE, FOURTH FLOOR, ALEXANDRIA, VA, 22314, US

(21) Appl. No.: 10/634,960

(22) Filed: Aug. 6, 2003

(51) Int. Cl. B02C 18/16

(52) U.S. Cl. 241/100; 241/236

(57) ABSTRACT

A mechanical delaying device of a shredder includes characteristics of a cantilever connected with a spindle at frames of blade assemblies, a roller accommodated around an axis shaft below the cantilever, a baffle fastened at a rear end of the axis shaft, a spring disposed between the roller and the baffle, a projecting gear axis disposed at an outer side of a fixing plate of one of the blade assemblies, and gear grooves provided at the gear axis for inserting the roller. When paper is not inserted, the roller presses against the spring and blocks at an outer side of the gear axis. When paper is inserted, paper is pressed downward for driving and rotating the spindle such that the roller is displaced outward and departed from the gear axis. A restoring force of the spring pushes the roller inward and the roller is stretched into the gear grooves of the gear axis. The roller is then pushed to an outermost side of the gear axis along with rotations of the gear axis being driven by an axis of the blade assemblies, thereby accomplishing delaying and halting purposes.

### BACKGROUND OF THE INVENTION

(a) Field of the Invention

The invention relates to shredder having a delaying and halting device using a spindle, a roller and a gear axis, and being capable of overcoming drawbacks as short-circuits and malfunctions of prior electronic delaying devices, thereby lengthening lifespan of the shredder.

(b) Description of the Prior Art

Common delaying devices of shredders usually adopt electronic components such as printed circuit boards, sensors and the like. However, these electronic delaying devices frequently result in malfunctions in the shredders due to humidity or poor contacts.

### SUMMARY OF THE INVENTION

The primary object of the invention is to provide a shredder having spindle at frames of blade assemblies, a roller accommodated around an axis shaft connected at a bottom portion of a cantilever at one end of the spindle, and a projecting gear axis at an outer side of a fixing plate of the blade assemblies. Using an interlocking relationship by inserting the roller into gear grooves of the gear axis, mechanical delaying and halting purposes are accomplished after inserting paper.

### BRIEF DESCRIPTION OF THE DRAWINGS

FIG. 1 shows an elevational view according to the invention.

FIG. 2 shows a partial structural view according to the invention.

FIG. 3 shows a partial sectional view of the frame in FIG. 2 according to the invention.

FIG. 4 shows a planar view illustrating the delaying device according to the invention not inserted with paper or having completed shredding.

FIG. 5 shows a motional schematic view of the spindle and the gear axis of the delaying device according to the invention.

FIG. 6 shows a planar view illustrating the delaying device according to the invention inserted with paper.

### DETAILED DESCRIPTION OF THE PREFERRED EMBODIMENTS

To better understand the invention, detailed descriptions shall be given with the accompanying drawings hereunder.

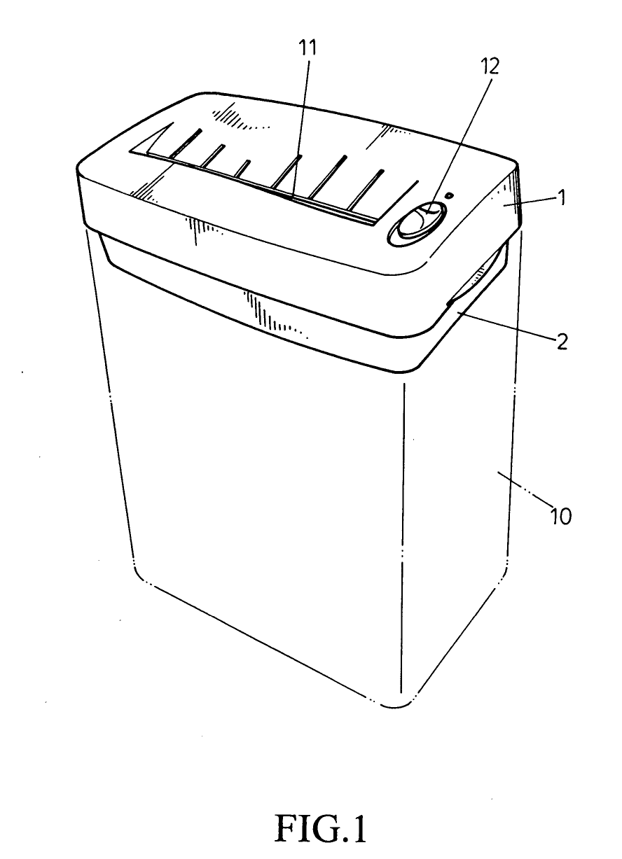

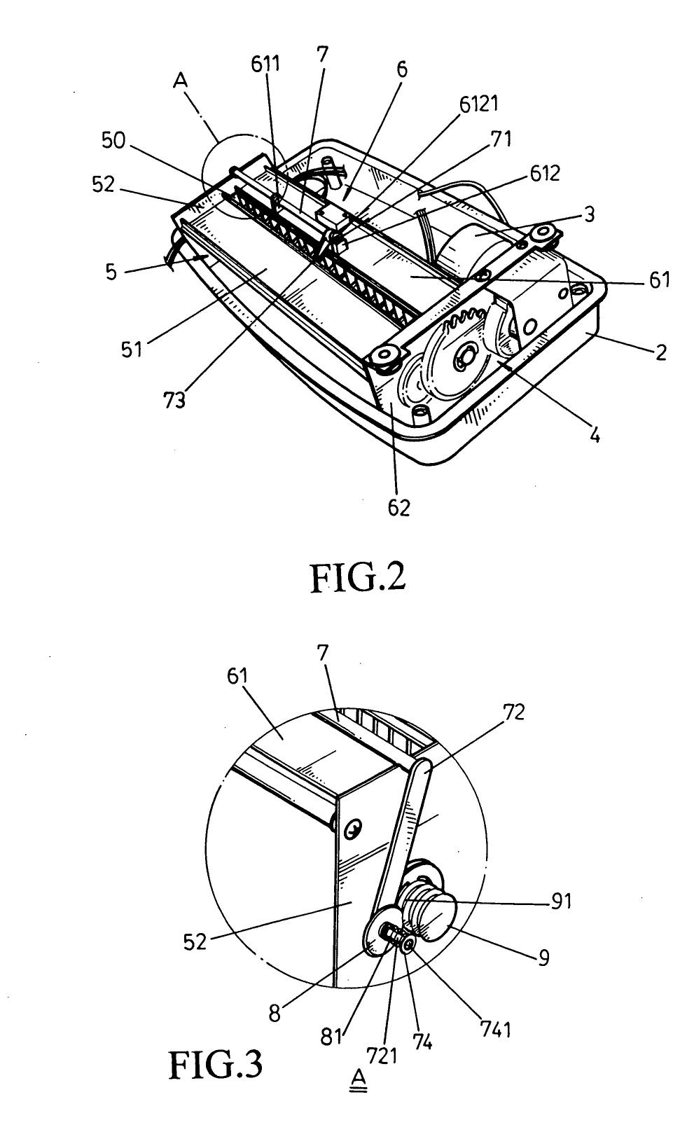

Referring to FIGS. 1 and 2, the invention comprises an upper lid 1, a base 2, a motor 3, a decelerator 4, and two blade assemblies 5 and 6. The upper lid 1 has a feeder 11 and a switch button 12 at a top portion thereof. The base 2 accommodates the motor 3, the decelerator 4, and the two blade assemblies 5 and 6 at an interior thereof, and has a shred container 10 at a bottom portion thereof. The motor 4 is for driving and rotating the decelerator 4 consisted of a plurality of gears, and the decelerator 4 is for driving and rotating the two blade assemblies 5 ad 6, thereby shredding paper. The two blade assemblies 5 and 6 are provided with U-shaped plastic frames 51 and 61 that have openings thereof facing outward, so as to form a long shredder slot 50 connected with the feeder 11 of the upper lid 1. The frames 51 and 61 of the two blade assemblies 5 and 6 are fastened at metal fixing plates 52 and 62 via two sides thereof, respectively. The characteristics of the two blade assemblies 5 and 6 are that:

the frame 61 of the right blade assembly 6 has two axis bases 611 and 612 for receiving a spindle 7 above; an axis 71 at one end the spindle 7 is penetrated into an axis opening 6121 of the axis base 612, whereas the other end of the spindle 7 is connected to a cantilever 72 as shown in FIG. 3; at a top portion of the spindle 7 near the axis opening 6121 is a pressing member 73, which is tilted downward to extend into the shredder slot 50 of the two blade assemblies 5 and 6, such that when paper is entered into the shredder slot 50, the pressing member 73 is simultaneously pressed downward for driving and rotating the spindle 7; a bottom portion of the cantilever 72 at one end the spindle 7 is connected with a transverse axis shaft 721 accommodated by a circular roller 8; a rear end of the axis shaft 721 is fastened with a circular baffle 74 using a screw bolt 741; the roller 8 and the baffle 74 are accommodated by a spring 81 in between such that the roller 8 is allowed with displacement by pressing against the spring 81 as shown in FIG. 3; an outer side of the fixing plate 51 of the blade assembly 6 is a projecting gear axis 9, which is connected and spontaneously moves with an axis of the blade assembly 6; and gear grooves 91 at the gear axis 9 are for placing the roller 8.

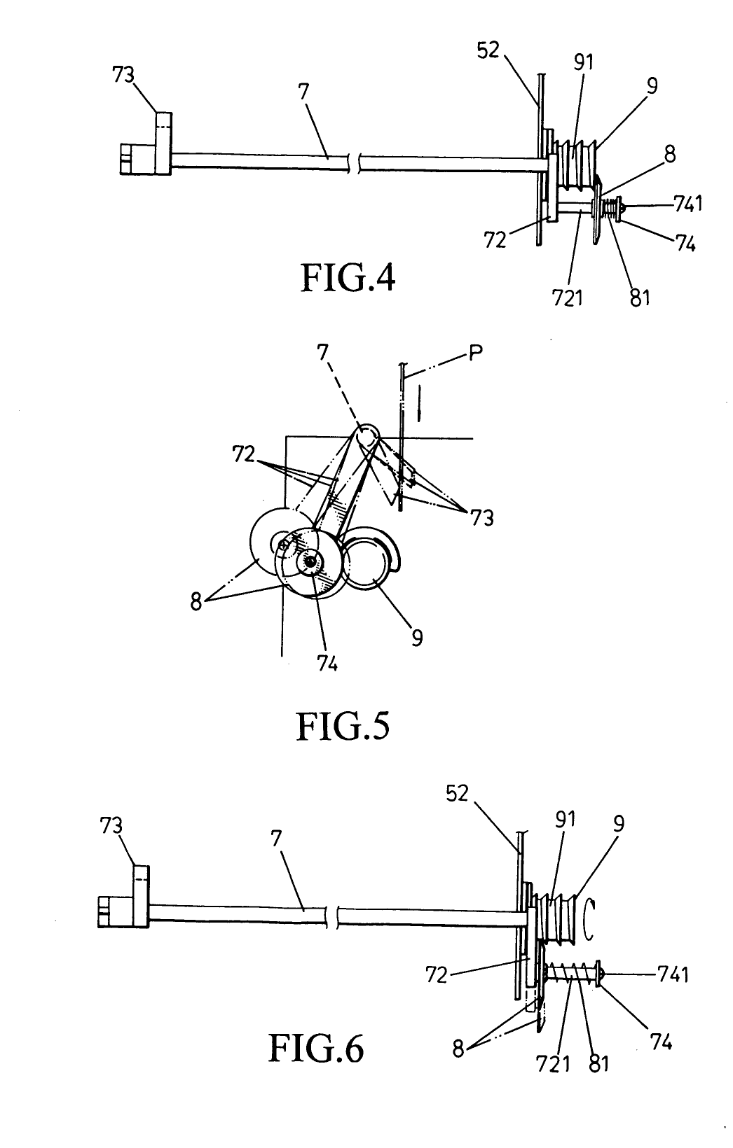

Referring to FIGS. 4 and 5, when paper P is not inserted, the roller 8 is pressed against the spring 81 and blocks at an outer side of the gear axis 9. When the paper P is inserted, the paper P downwardly presses the pressing member 73 that further drives and rotates the spindle 7 below. Referring to FIG. 5, the roller 8 is displaced outward or upward so as to depart from the gear axis 9. A restoring force of the spring 81 pushes the roller 8 inward with a section at a time as shown in FIG. 6. Referring to FIG. 4, the roller 8 is stretched into the gear grooves 91 of the gear axis 9, and is pushed toward an outermost end of the gear axis 9 along with rotation of the gear axis 9 by the axis of the shredding blade assembly 6. At this point, the shredder comes to a halt for having completed shredding, thereby accomplishing the objects of delaying and halting.

Conclusive from the above, the invention utilizes an interlocking relationship between the spindle, the roller and the gear axis for accomplishing delaying and halting of the shredder, and advances over drawbacks such as short-circuits and malfunctions of electronic sensors and printed circuit boars in the prior shredder.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A mechanical delaying device of a shredder comprising an upper lid, a base, a motor, a decelerator, and two blade assemblies; wherein:
the upper lid has a feeder and a switch button at a top portion thereof; the base accommodates the motor, the decelerator, and the two blade assemblies at an interior thereof, and has a shred container at a bottom portion thereof; the motor is for driving and rotating the decelerator consisted of a plurality of gears, and the decelerator is for driving and rotating the two blade assemblies; the two blade assemblies are provided a long shredder slot connected with the feeder of the upper lid; the frames of the two blade assemblies fare fastened to the fixing plates via two sides thereof, respectively; and
the characteristics thereof being that:
the frame of the right blade assembly has two axis bases for receiving a spindle above; an axis at one end the spindle is penetrated into an axis opening of the axis base, whereas the other end is connected to a cantilever; at a top portion of the spindle near the axis opening is a pressing member, which is tilted downward to extend into the shredder slot of the two blade assemblies; a bottom portion of the cantilever at one end the spindle is connected with a transverse axis shaft accommodated by a circular roller; a rear end of the axis shaft is fastened with a circular baffle using a screw bolt; the roller and the baffle are accommodated by a spring in between such that the roller is allowed with displacement by pressing against the spring; an outer side of the fixing plate of the blade assembly is a projecting gear axis, which is connected and spontaneously moves with the axis of the right blade assembly; and gear grooves at the gear axis are for placing the roller; when paper is not inserted, the roller is pressed against the spring and blocked at an outer side of the gear axis; and
when the paper is inserted, the paper downwardly presses the pressing member that further drives and rotates the spindle below; the roller is displaced outward or upward and departed from the gear axis; a restoring force of the spring pushes the roller inward; and the roller is stretched into the gear grooves of the gear axis, and is pushed toward an outermost end of the gear axis along with rotation of the gear axis by the axis of the shredding blade assembly, thereby accomplishing the objects of delaying and halting.
